(19) United States
(12) Patent Application Publication
(10) Pub. No.: US 2020/0364277 A1
(43) Pub. Date: Nov. 19, 2020

(54) SYSTEMS AND METHODS FOR RECOMMENDING CONTENT SUBSCRIPTIONS

(71) Applicant: Facebook, Inc., Menlo Park, CA (US)

(72) Inventors: Kai Wang, Issaquah, WA (US); Muhammed Elsayed Ibrahim, Seattle, WA (US)

(21) Appl. No.: 16/410,958

(22) Filed: May 13, 2019

(51) Int. Cl. G06F 16/9535; G06F 16/9536; G06F 16/9538

(52) U.S. Cl. CPC G06F 16/9535; G06F 16/9538; G06F 16/9536

(57) ABSTRACT

Systems, methods, and non-transitory computer-readable media can be configured to generate an embedding for a content item based at least in part on a set of features associated with the content item. A topic to which the content item is related can be determined based at least in part on the embedding. The content item can be provided to a user based at least in part on the topic and a topic subscription to which the user is subscribed.

### FIELD OF THE INVENTION

The present technology relates to the field of networked communications. More particularly, the present technology relates to techniques for generating recommendations for content subscriptions in a computerized networking system.

### BACKGROUND

Today, people often utilize computing devices (or systems) for a wide variety of purposes. For example, users can use their computing devices to interact with other users, create content, share content, and view content. In some cases, users can utilize their computing devices to access a social network and post content to the social network. Content posted to the social network may include text content items and media content items, such as audio, images, and videos. The posted content may be published to the social network for consumption by others.

### SUMMARY

Various embodiments of the present technology can include systems, methods, and non-transitory computer readable media configured to generate an embedding for a content item based at least in part on a set of features associated with the content item. A topic to which the content item is related can be determined based at least in part on the embedding. The content item can be provided to a user based at least in part on the topic and a topic subscription to which the user is subscribed.

In some embodiments, a set of content items related to the topic can be aggregated. The set of content items can be ranked based at least in part on a relevance associated with each content item.

In some embodiments, a subset of content items can be determined based at least in part on whether each content item exceeds a threshold ranking. The subset of content items can be provided to the user.

In some embodiments, ranking the set of content items comprises generating an embedding based at least in part on a set of features associated with each content item. A proximity of each content item to an embedding of a labeled content item related to the topic can be determined. The relevance associated with each content item can be determined based at least in part on the proximity.

In some embodiments, one or more user preferences can be determined based at least in part on user signals associated with the user. Ranking the set of content items can be further based at least in part on the one or more user preferences.

In some embodiments, one or more interested topics to which the user is interested can be determined based at least in part on user signals associated with the user. One or more topic subscription recommendations can be provided to the user based at least in part on the one or more interested topics.

In some embodiments, user signals associated with the user can comprise of user features associated with the user and user actions performed by the user.

In some embodiments, the user can be subscribed to one or more topic subscriptions based at least in part on the user opting-in to at least one of the one or more topic subscription recommendations.

In some embodiments, the user can be unsubscribed from the one or more topic subscriptions based at least in part on the user opting-out from the one or more topic subscriptions.

In some embodiments, additional content items related to the topic are provided to the user monthly, bi-weekly, weekly, daily, or some other specified time interval.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an example subscription module, according to an embodiment of the present technology.

FIG. 2A illustrates an example of a user module, according to an embodiment of the present technology.

FIG. 2B illustrates an example of a content topic module, according to an embodiment of the present technology.

FIG. 3 illustrates an example of a functional block diagram, according to an embodiment of the present technology.

FIG. 4 illustrates an example interface, according to an embodiment of the present technology.

FIG. 5 illustrates an example process for recommending a topic-based page subscription, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for Recommending Content Subscriptions

Today, people often utilize computing devices (or systems) for a wide variety of purposes. For example, users can use their computing devices to interact with other users, create content, share content, and view content. In some cases, users can utilize their computing devices to access a social network and post content to the social network. Content posted to the social network may include text content items and media content items, such as audio, images, and videos. The posted content may be published to the social network for consumption by others.

Under conventional approaches, a social network (or social networking system) can publish a variety of content items (e.g., audio, images, videos, movies, events, offers, applications, etc.) that a user can access. The user may access the variety of content items as they navigate to various pages accessible through the social networking system. As the user browses the various pages, the user may find some content items to correspond to an interesting topic and may wish to view additional content items of the same interesting topic. The social networking system can keep the user engaged as well as enhance the overall user experience by providing such content items. Further, the social networking system can continue to keep the user engaged and enhance the overall user experience by periodically providing the user with new, updated, or unviewed content items that correspond to the same interesting topic. However, under conventional approaches, identifying a topic that a user finds interesting and identifying content items related to that topic presents significant challenges. Further, as the number of content items and content types available on the social networking system continues to grow, so too do the challenges of identifying content items that relate to a given topic. Accordingly, conventional approaches for identifying a topic in which a user is interested and identifying content items associated with the topic can be ineffective and unable to scale as the number of content items available through the social networking system continues to increase. Thus, such conventional approaches are not effective in addressing these and other problems arising in computer technology.

An improved approach rooted in computer technology overcomes the foregoing and other disadvantages associated with conventional approaches specifically arising in the realm of computer technology. In various embodiments, the present technology can determine one or more topics in which a user is interested based on a variety of user signals. Such topics can vary in levels of granularity. For example, the topics can include broad topics, such as sports, to specific topics, such as a specific player of a specific sport. In various embodiments, example user signals that can be used to identify the one or more topics can include user features (e.g., age, gender, geographical location, etc.) associated with the user and user actions (e.g., liking a content item, sharing a content item, etc.) performed by the user. After determining the one or more topics of interest, the present technology can recommend corresponding topic subscriptions for the one or more topics to the user. In general, a topic subscription is an option that users can select to subscribe to a particular topic. Once the user selects a topic subscription for a given topic, the present technology can periodically provide the user with content items (e.g., pages, audio, images, videos, movies, events, offers, applications, etc.) of various content types that correspond to the subscribed topic. For example, a user may like a page associated with a topic that references basketball. Based on the user's action of liking the page and a geographical location associated with the user, the present technology may determine that the user may be interested in a topic that references a basketball team associated with the user's geographical location. In this example, the present technology may recommend a topic subscription for the basketball team. Upon selecting the topic subscription, the present technology can periodically provide the user with content items of various content types related to the basketball team. Accordingly, the present technology can periodically provide the user with content items that the user may find interesting, thereby keeping the user engaged and improving user experience. Additional details relating to the present technology are provided below.

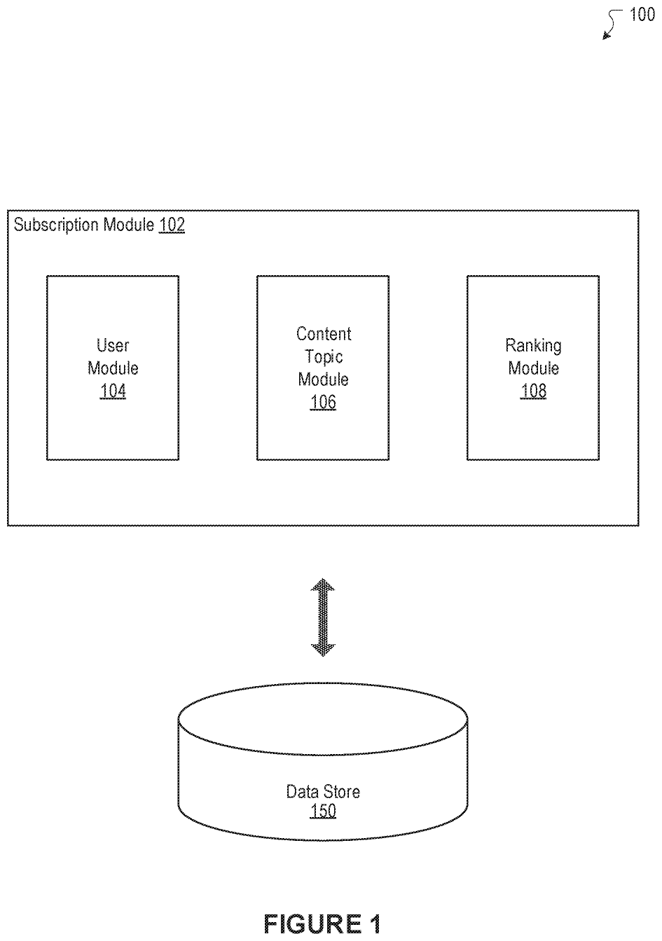

FIG. 1 illustrates an example system 100 including an example subscription module 102, according to an embodiment of the present technology. As shown in the example of FIG. 1, the subscription module 102 can include a user module 104, a content topic module 106, and a ranking module 108. In some embodiments, the example system 100 can include at least one data store 150. The components (e.g., modules, elements, etc.) shown in this figure and all figures herein are exemplary only, and other implementations may include additional, fewer, integrated, or different components. Some components may not be shown so as not to obscure relevant details.

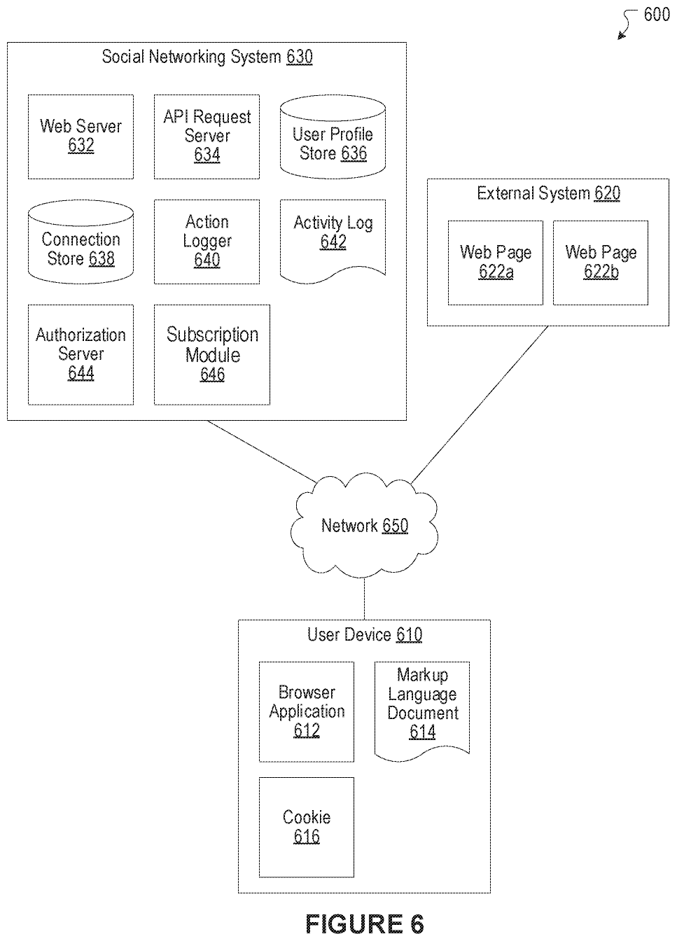

In some embodiments, the subscription module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the subscription module 102 or at least a portion thereof can be implemented using one or more computing devices or systems that include one or more servers, such as network servers or cloud servers. In some instances, the subscription module 102 can, in part or in whole, be implemented within or configured to operate in conjunction with a social networking system (or service), such as the social networking system 630 of FIG. 6. In some instances, the subscription module 102 can be, in part or in whole, implemented within or configured to operate in conjunction or be integrated with a client computing device, such as the user device 610 of FIG. 6. For example, the subscription module 102 can be implemented as or within a dedicated application (e.g., app), a program, or an applet running on a user computing device or client computing system. The application incorporating or implementing instructions for performing some, or all, functionality of the subscription module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The subscription module 102 can be configured to communicate and/or operate with the at least one data store 150, as shown in the example system 100. The at least one data store 150 can be configured to store and maintain various types of data including, for example, information describing user signals and topic subscriptions. In some implementations, the at least one data store 150 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 150 can store information associated with users, such as user identifiers, user information, profile information, user specified settings, content produced or posted by users, and various other types of user data.

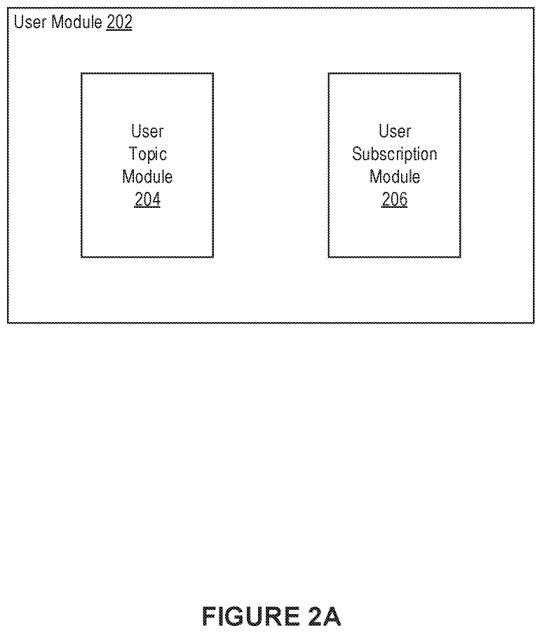

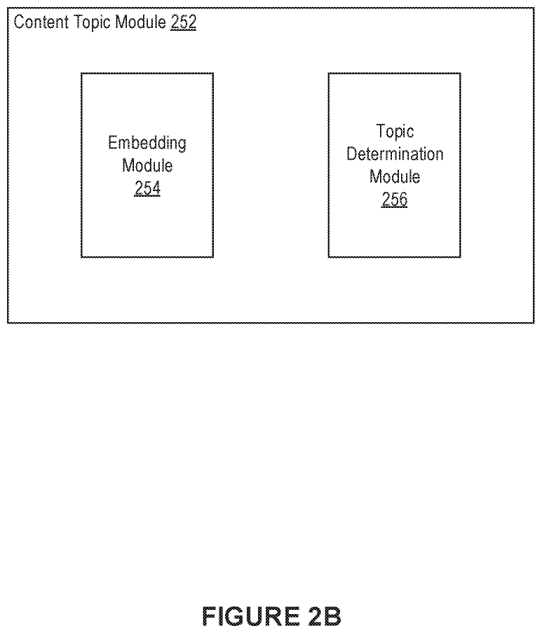

In various embodiments, the user module 104 can provide users with access to topic subscriptions for various topics. For example, the user module 104 can determine one or more topics that are of interest to a user. The user module 104 can then provide the user with recommendations for one or more topic subscriptions based on the one or more topics along with corresponding options to subscribe to the one or more topic subscriptions. More details regarding the user module 104 will be provided below with reference to FIG. 2A.

In various embodiments, the content topic module 106 can determine one or more topics to which content items are related. Content items related to a topic can be provided to a user that subscribed to a topic subscription corresponding to the topic. In some embodiments, the content topic module 106 can determine one or more topics to which a content item is related based on an embedding for the content item. In general, the embedding can be a numerical (e.g., vector) representation of the content item. The embedding can describe various features associated with the content item and, when compared with embeddings of other content items, describe various interrelationships between the content item and other content items. The content topic module 106 can generate the embedding for the content item based on various features associated with the content item. The embedding can be mapped to a vector space and compared with embeddings of other content items. Based on comparisons with the embedding and the embeddings of other content items, the content topic module 106 can determine one or more topics to which the content item is related. For example, the content topic module 106 can generate an embedding for a page accessible through the social networking system based on various page features associated with the page. The embedding for the page can be mapped to a vector space and compared with embeddings of other pages. The embedding may, for example, be within a threshold proximity (or distance) of embeddings of other pages that relate to a topic, such as baseball. Accordingly, the content topic module 106 can determine that the page is also related to baseball. While this example, and other examples provided herein, refer to pages, the approaches described herein can also be applied to myriad other types of content items (e.g., audio, images, videos, movies, events, offers, applications, etc.). More details regarding the content topic module 106 will be provided below with reference to FIG. 2B.

In various embodiments, the ranking module 108 can aggregate and rank content items to be provided through topic subscriptions. In general, content items can be of different content types (e.g., audio, images, videos, movies, events, offers, applications, etc.) and shared through various pages accessible through the social networking system. The ranking module 108 can aggregate such content items based on one or more topics to which the content items relate. These topics can correspond to topic subscriptions to which users can subscribe. In some embodiments, the ranking module 108 can aggregate content items by aggregating pages through which the content items are shared. Accordingly, the ranking module 108 can aggregate content items to be provided through topic subscriptions by aggregating pages through which the content items are shared. For example, the ranking module 108 can aggregate various content items related to a certain basketball player by aggregating pages through which the various content items are shared. The various content items can include, for example, videos depicting the certain basketball player and posts made by the certain basketball player. These pages can be provided to a user subscribed to a topic subscription related to the certain basketball player. Many variations are possible. In some embodiments, the ranking module 108 can select a subset of content items from a set of aggregated content items. Selecting a subset of content items can reduce an overall number of content items that the ranking module 108 ranks. The ranking module 108 can select the subset based on an initial categorization. In some embodiments, an initial categorization can filter content items that do not satisfy a threshold level of relevance to a topic. For example, a content item may have a corresponding embedding that, when mapped to a vector space, is not within a threshold proximity to embeddings of other pages related to a topic. Accordingly, the content item may not satisfy a threshold level of relevance for the topic. In some embodiments, an initial categorization can be based in part on geographical location. For example, the ranking module 108 can select a subset of content items that are associated with geographical locations that are within a threshold proximity of a geographical location associated with a user. In some embodiments, the ranking module 108 can randomly select a subset of content items. Many variations are possible.

In various embodiments, the ranking module 108 can also rank content items based in part on embeddings associated with the content items and user signals associated with a user. As described in further detail herein, embeddings for content items can describe various features associated with the content items. In some embodiments, the ranking module 108 can, based on embeddings associated with content items, determine a relevancy of each content item to a topic. A relevancy of a content item to a topic can, for example, be based on an embedding corresponding to the content item and a proximity of the embedding to embeddings of other content items related to the topic. The ranking module 108 can rank each content item based on the relevancy of each content items to the topic. Content items that are of greater relevance to a topic can be ranked higher than content items that are of lower relevance to the topic. For example, a content item with a corresponding embedding that is within a closer proximity to embeddings of other content items related to a topic can have a greater relevance and be ranked higher than another content item with a corresponding embedding that is within a farther proximity. In some embodiments, content items with a relevance that exceeds a threshold relevance are provided through a topic subscription. User signals, as described in further detail herein, can be a basis for determining topics in which a user is interested. Further, user signals can indicate various user preferences associated with the user. The ranking module 108 can, based on user signals, determine various user preferences associated with a user and, accordingly, rank content items based on the user preferences. Content items that a user, based on the user's user preferences, is more likely to prefer can be ranked higher than content items that the user is less likely to prefer. For example, the ranking module 108 can, based on user signals associated with a user, determine that the user prefers video content items. Accordingly, in a topic subscription for the user, the ranking module 108 can rank video content items higher than other content items. In some embodiments, content items with a ranking, based on user preferences or relevancy, that exceeds a threshold ranking are provided through a topic subscription. As such, a topic subscription for a user can be personalized based on the preferences of the user.

FIG. 2A illustrates an example of a user module 202 configured to provide users with topic subscriptions for various topics, according to an embodiment of the present technology. For example, the user module 202 can determine one or more topics that are of interest to a user. The user module 202 can then provide the user with recommendations for one or more topic subscriptions based on the one or more topics along with corresponding options to subscribe to the one or more topic subscriptions. In some embodiments, the user module 104 of FIG. 1 can be implemented as the user module 202. As shown in FIG. 2A, the user module 202 can include a user topic module 204 and a user subscription module 206.

The user topic module 204 can determine one or more topics in which a user is interested. In some embodiments, topics of interest to a user may be determined based on user signals associated with a user. For example, user signals can include user features associated with the user and user actions performed by the user through the social networking system. In general, various features associated with a user and various actions the user performs can be indicative of what the user may find interesting. As such, the user topic module 204 can utilize a wide variety of user signals to determine topics in which a user is interested. In various embodiments, the user topic module 204 can implement one or more machine learning models to predict topics of interest for users based on their respective user features, user actions, or a combination thereof. In some embodiments, user features can include, for example, user demographic information such as age, gender, geographical location (e.g., country, state, county, city, etc.), education, and profession. In some embodiments, user features can include features pertaining to a social network such as people or pages a user is following in the social networking system, pages the user has liked through the social networking system, pages to which the user has posted a comment through the social networking system, or groups the user has joined through the social networking system. In some embodiments, user features can include features describing certain tendencies such as a rate or frequency with which a user likes, shares, or comments on a page or a content item through the social networking system. The user topic module 204 can determine a topic in which a user is interested based in part on such user features. For example, a user may be following a page associated with football. The user may also be located in, for example, San Francisco, California. Based on the page the user is following and the geographical location associated with the user, the user topic module 204 can determine that the user may be interested in a football team associated with San Francisco, California. In addition to user features, topics for the user can also be determined based on actions performed by the user through the social networking system. In some embodiments, user actions can include various interactions with a social network, such as liking, sharing, or commenting on a page or a content item; visiting a page; consuming a content item; or purchasing a product. The user topic module 204 can determine a topic in which a user is interested based in part on such user actions. For example, a user may visit a page associated with a professional football player. The user may like the page and comment on the page. Based in part on these user actions, the user topic module 204 can determine that the user may be interested in the professional football player. Many variations are possible.

The user subscription module 206 can recommend one or more topic subscriptions to a user and provide the user with options to subscribe to one or more topic subscriptions. The user subscription module 206 can recommend topic subscriptions to a user based on topics in which the user is interested. Topics in which the user is interested can be determined, for example, by the user topic module 204, as described herein. For example, the user topic module 204 can determine that a user is interested in a number of topics, such as basketball, dogs, and trees. Based on these topics, the user subscription module 206 can recommend corresponding topic subscriptions for basketball, dogs, and trees to the user. In some embodiments, the user subscription module 206 provides an interface through which a user can subscribe or opt-in to topic subscriptions. The interface can be provided through a page accessible through the social networking system. The interface can, for example, display a list of recommended topic subscriptions to which the user can subscribe. In the foregoing example, the user may decide to select topic subscriptions for basketball and trees. Accordingly, the user subscription module 206 would subscribe the user to topic subscriptions for basketball and trees. In some embodiments, a subscription to a topic can provide periodic notifications of new or updated content items that relate to that topic. A subscription to a topic can also provide periodic notifications of content items relating to that topic that a user has not previously accessed or viewed. Periodic notifications can be monthly, bi-weekly, weekly, daily, or some other specified time interval. Many variations are possible. In some embodiments, the user subscription module 206 also provides a user with options to unsubscribe or opt-out from a topic subscription. For example, once a user has subscribed to a topic subscription, the user subscription module 206 can provide an interface through which the user can unsubscribe from the topic subscription.

FIG. 2B illustrates an example of a content topic module 252 configured to determine one or more topics related to content items, according to an embodiment of the present technology. In some embodiments, the content topic module 106 of FIG. 1 can be implemented as the content topic module 252. As shown in FIG. 2B, the content topic module 252 can include an embedding module 254 and a topic determination module 256.

The embedding module 254 can generate embeddings for content items based on various features associated with the content items. Such embeddings can be utilized to determine one or more topics with which the content items are associated. The embedding module 254 can generate embeddings based on various generally known machine learning techniques. The embedding module 254 can train and apply a machine learning model to generate an embedding for a content item based on features associated with the content item. For example, to generate a page embedding, the embedding module 254 can utilize a machine learning model trained to output page embeddings for a page based on page features associated with the page. Some examples of page features of a page can include an author (e.g., user or entity who created the page), a creation timestamp (i.e., when the page was created), a last updated timestamp (i.e., when the page was last updated), a number of posts published through the page, a frequency of posts (or how often posts are published to the page), a timestamp corresponding to a most recent post in the page, a number of comments published through the page, a frequency of comments (or how often comments are published to the page), a timestamp corresponding to a most recent comment associated with the page, a frequency of responses to comments (or how often responses to comments are posted to the page), and co-visitation information identifying other pages that users visited or liked in addition to the page, to name some examples. For example, a local coffee shop owner may create a page to promote the coffee shop. In this example, page features for the page may identify products and services the coffee shop provides, its location, and its business hours. The page features may also include ratings or reviews of the coffee shop and co-visitation information. These page features can serve as a basis for generating a page embedding for the page. While the example provided herein describes generating an embedding for a page, the principles described apply to other types of content items (e.g., audio, images, videos, movies, events, offers, applications, etc.) as well. The embedding module 254 can generate embeddings for other types of content items based on similar features associated with the content items. For example, the embedding module 254 can generate a movie embedding for a movie based on features associated with the movie. Many variations are possible.

The topic determination module 256 can determine one or more topics to which a content item relates based in part on an embedding of the content item. In general, when embeddings for content items are within a threshold proximity to each other, that proximity can be indicative of a similarity between the respective content items. In some cases, an embedding may be within a threshold proximity to embeddings of one or more content items that have been labeled as related to one or more topics. The topic determination module 256 can determine a topic to which a content item relates based on an embedding of the content item and a proximity of the embedding to embeddings of other content items that are labeled as related to the topic. For example, when determining topics to which a content item relates, the topic determination module 256 can map an embedding of the content item to a vector space. Similarly, embeddings for other content items that have been labeled as related to a topic can also be mapped to the vector space. The topic determination module 256 can determine topics related to the content item based on a proximity between the embedding for the content item and the embeddings for the other content items in the vector space. For example, a content item may have a corresponding embedding that is within a threshold proximity to embeddings of other content items that have been labeled as related to basketball. Accordingly, the topic determination module 256 can determine that the content item is related to basketball. In some cases, an embedding may be within a threshold proximity to embeddings of multiple content items that are related to different topics. In some embodiments, the topic determination module 256 can determine multiple topics for the content item based on the embedding of the content item being within a threshold proximity to embeddings of other content items that are each associated with one or more of the multiple topics. For example, an embedding of a content item may be within a threshold proximity to embeddings of content items related to basketball and content items related to movies. The topic determination module 256 can accordingly determine that the content item is related to both basketball and movies. The content item can be provided, for example, through a topic subscription for basketball and a topic subscription for movies. In some embodiments, the topic determination module 256 can determine a respective relevance of each topic that was determined for a content item. For example, the topic determination module 256 can determine a relevance of a first topic to which a content item relates based on a proximity between an embedding of the content item to embeddings of other content items related to the first topic. Similarly, the topic determination module 256 can determine a relevance of a second topic to which a content item relates based on a proximity between the embedding of the content item to embeddings of other content items related to the second topic. A content item can have a higher relevance to the first topic than the second topic if an embedding of the content item is closer in proximity to embeddings of content items related to the first topic and farther in proximity to embeddings of content items related to the second topic. For example, an embedding can be generated for a new page published to the social networking system. The topic determination module 256 can, based on the embedding and its proximity to embeddings of other pages, determine that the embedding is within a threshold proximity to embeddings of pages related to baseball, for example. Accordingly, the topic determination module 256 can determine that the new page is related to baseball. The new page may be provided, for example, through a topic subscription for baseball.

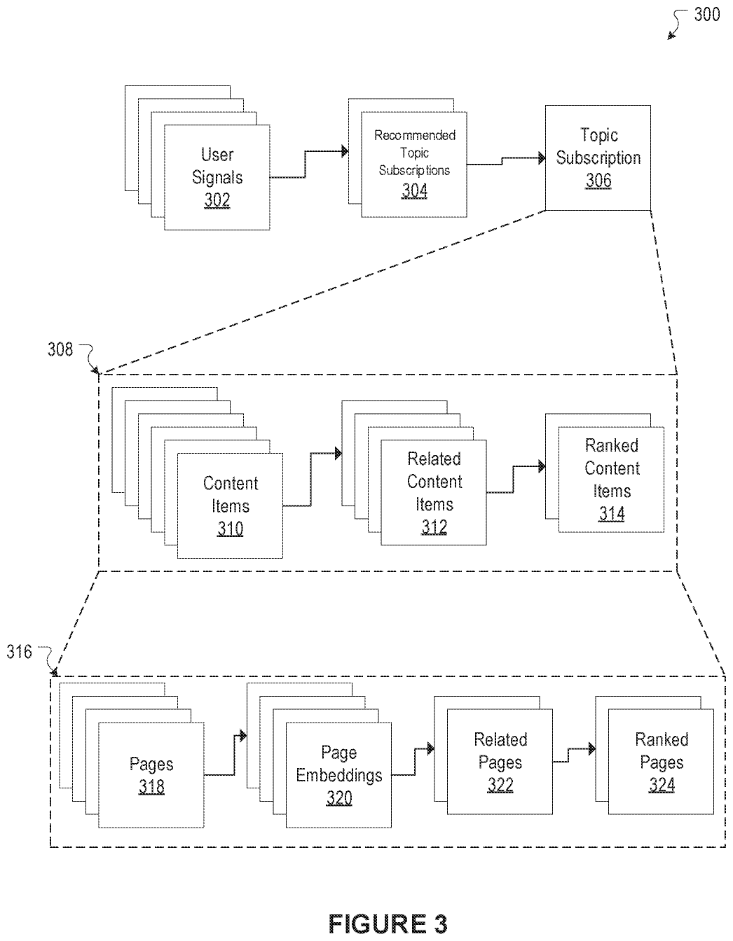

FIG. 3 illustrates an example functional block diagram 300, according to an embodiment of the present technology. In this example, a user can subscribe to a topic subscription and be provided with content based on the topic subscription. A set of user signals 302 associated with the user can be utilized to determine one or more topics in which the user is interested. The set of user signals 302 can include user features associated with the user and user actions performed by the user, as described herein. The one or more topics in which the user is interested can be determined by, for example, the user topic module 204, as described herein. Based on the one or more topics, a set of recommended topic subscriptions 304 can be provided to the user. The set of recommended topic subscriptions 304 can, for example, be provided by the user subscription module 206, as described herein. The user can subscribe to a topic subscription 306 included in the recommended topic subscriptions. At block 308, content to be provided through the topic subscription 306 can be aggregated and ranked. For example, a set of related content items 312 can be aggregated based on a set of content items 310. The set of related content items 312 can be aggregated, for example, by the ranking module 108, as described herein. The set of related content items 312 can be ranked to generate a set of ranked content items 314. The set of ranked content items 314 can be ranked, for example, by the ranking module 108, as described herein. The set of ranked content items 314 can be provided to the user through the topic subscription 306. At block 316, the set of related content items 312 are determined based on embeddings of content items 310. As an example, the set of content items 310 can include a set of pages 318. A set of page embeddings 320 can be generated based on the set of pages 318. The set of page embeddings 320 can be generated, for example, by the embedding module 254. From the page embeddings, a set of related pages 322 that relate to the topic of the topic subscription 306 can be determined. The set of related pages 322 can be determined, for example, by the topic determination module 256. The set of related pages 322 can be ranked to generate a set of ranked pages 324. In this example, block 316 can be just one example of determining pages that are related to a topic and the principles described herein can apply to other types of content items (e.g., audio, images, videos, movies, events, offers, applications, etc.). All examples herein are provided for illustrative purpose and there can be many variations and other possibilities.

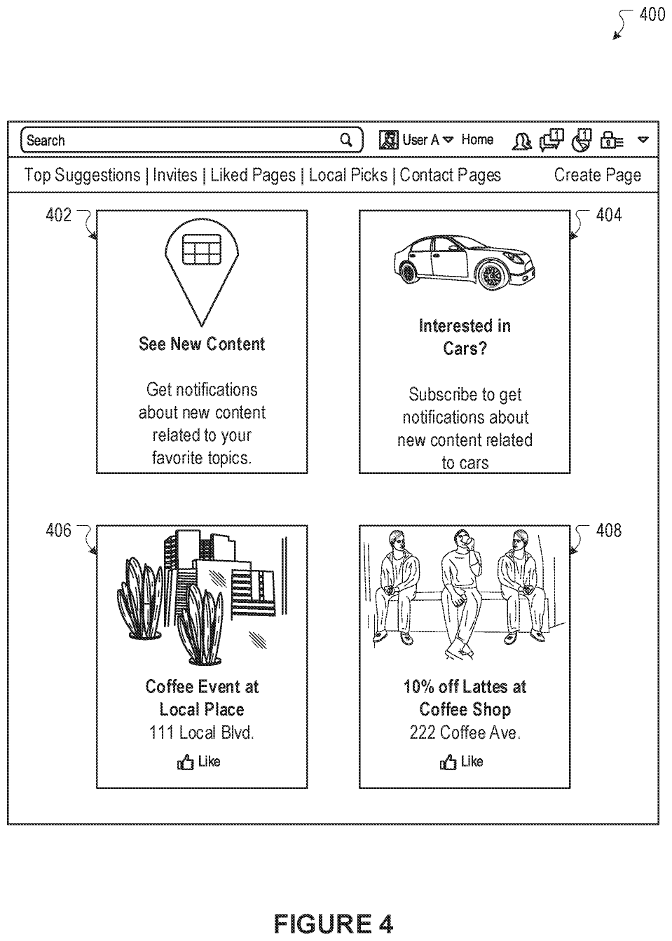

FIG. 4 illustrates an example interface 400, according to an embodiment of the present technology. The example interface 400 can be supported or implemented by, for example, by the user subscription module 206, as described herein. In this example, a user is provided with a new subscriptions option 402 which, upon selection, can provide the user with various topic subscriptions as recommendations. The interface 400 can also provide the user with a recommended topic subscription option 404. The recommended topic subscription option 404 can be provided to the user based on a determination that the user is interested in the topic, e.g., cars. Accordingly, the recommended topic subscription option 404 provides the user with an option to subscribe or opt-in to a topic subscription based on the user's interest in cars. The user can select topic subscription option 404 to subscribe to a topic subscription for cars. The topic subscription for cars can allow for the user to be provided with content items related to cars. In another example, an event option 406 can be provided to the user based on the user having subscribed to a topic subscription for coffee. The event option 406 can notify the user of a coffee event occurring nearby. In yet another example, an offer option 408 can be provided to the user based on the user having subscribed to a topic subscription for coffee. The offer option 408 can notify the user of an offer promoted by a nearby coffee shop. All examples herein are provided for illustrative purposes, and there can be many variations and other possibilities.

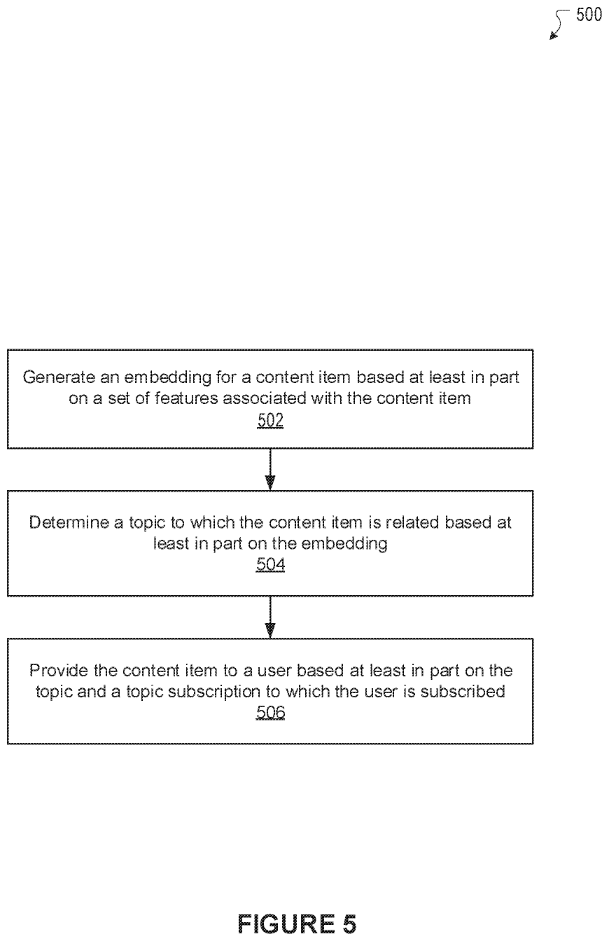

FIG. 5 illustrates an example method 500 for providing a content item to a user, according to an embodiment of the present technology. At block 502, the example method 500 can generate an embedding for a content item based at least in part on a set of features associated with the content item. The embedding can be generated, for example, by the embedding module 254, as described herein. At block 504, the example method 500 can determine a topic to which the content item is related based at least in part on the embedding. The topic can be determined, for example, by the topic determination module 256, as described herein. At block 506, the example method 500 can provide the content item to a user based at least in part on the topic and a topic subscription to which the user is subscribed. The content item can be provided, for example, by the user subscription module 206, as described herein. It should be understood that there can be additional, fewer, or alternative steps performed in similar or alternative orders, or in parallel, based on the various features and embodiments discussed herein unless otherwise stated.

It is contemplated that there can be many other uses, applications, and/or variations associated with the various embodiments of the present technology. For example, in some cases, user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a computer system executing, for example, a Microsoft Windows compatible operating system (OS), macOS, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects another user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a subscription module 646. The subscription module 646, for example, can be implemented as some or all of the functionality of the subscription module 102 of FIG. 1. In some embodiments, some or all of the functionality of the subscription module 646 can be implemented in the user device 610. As discussed previously, it should be appreciated that there can be many variations or other possibilities.

### Hardware Implementation

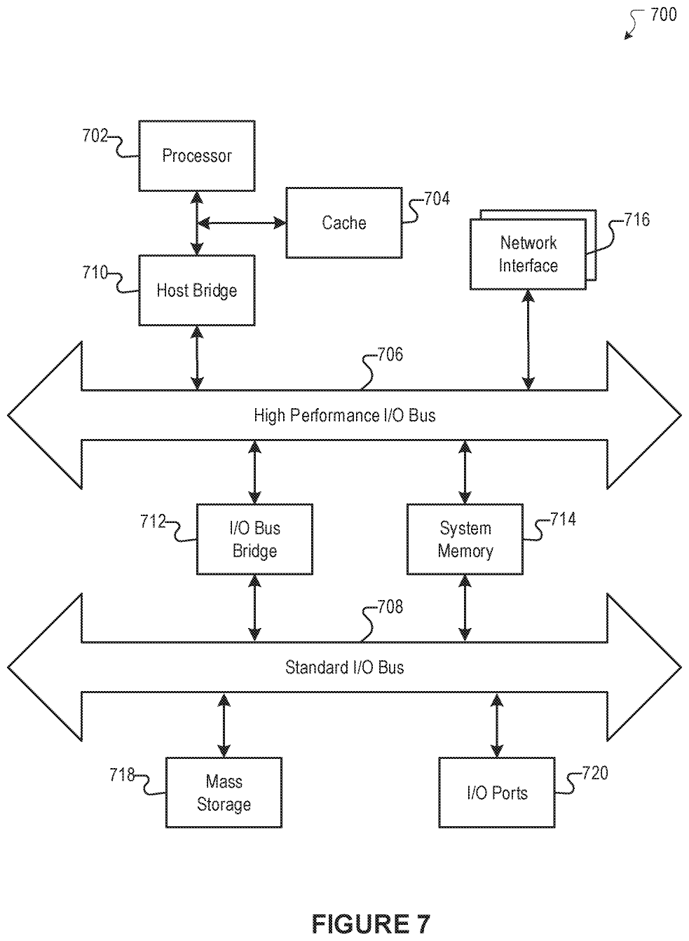

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module,” with processor 702 being referred to as the “processor core.” Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the embodiments of the invention are intended to be illustrative, but not limiting, of the scope of the invention, which is set forth in the following claims.

What is claimed is:

1. A computer-implemented method comprising:
generating, by a computing system, an embedding for a content item based at least in part on a set of features associated with the content item;
determining, by the computing system, a topic to which the content item is related based at least in part on the embedding; and
providing, by the computing system, the content item to a user based at least in part on the topic and a topic subscription to which the user is subscribed.

2. The computer-implemented method of claim 1, further comprising:
aggregating, by the computing system, a set of content items related to the topic; and
ranking, by the computing system, the set of content items based at least in part on a relevance associated with each content item.

3. The computer-implemented method of claim 2, further comprising:
determining, by the computing system, a subset of content items that satisfy a threshold ranking; and
providing, by the computing system, the subset of content items to the user.

4. The computer-implemented method of claim 2, wherein ranking the set of content items comprises:
generating an embedding for a content item in the set of content items based at least in part on a set of features associated with the content item;
determining a proximity of the embedding for the content item to an embedding of a labeled content item related to the topic; and
determining a respective relevancy to the topic for the content item based at least in part on the proximity.

5. The computer-implemented method of claim 2, further comprising:
determining, by the computing system, one or more user preferences based at least in part on user signals associated with the user; and
wherein ranking the set of content items is further based at least in part on the one or more user preferences.

6. The computer-implemented method of claim 1, further comprising:
determining, by the computing system, one or more interested topics to which the user is interested based at least in part on user signals associated with the user; and
providing, by the computing system, one or more topic subscription recommendations to the user based at least in part on the one or more interested topics.

7. The computer-implemented method of claim 6, wherein user signals associated with the user comprises user features associated with the user and user actions performed by the user.

8. The computer-implemented method of claim 6, further comprising:
causing, by the computing system, the user to be subscribed to one or more topic subscriptions based at least in part on the user subscribing to at least one of the one or more topic subscription recommendations.

9. The computer-implemented method of claim 6, further comprising:
causing, by the computing system, the user to be unsubscribed from the one or more topic subscriptions based at least in part on the user unsubscribing from the one or more topic subscriptions.

10. The computer-implemented method of claim 1, wherein additional content items related to the topic are provided to the user monthly, bi-weekly, weekly, daily, or based on some other specified time interval.

11. A system comprising:
at least one processor; and
a memory storing instructions that, when executed by the at least one processor, cause the system to perform:
generating an embedding for a content item based at least in part on a set of features associated with the content item;
determining a topic to which the content item is related based at least in part on the embedding; and
providing the content item to a user based at least in part on the topic and a topic subscription to which the user is subscribed.

12. The system of claim 11, further comprising:
aggregating a set of content items related to the topic; and
ranking the set of content items based at least in part on a relevance associated with each content item.

13. The system of claim 12, further comprising:
determining a subset of content items based at least in part on whether each content item exceeds a threshold ranking; and
providing the subset of content items to the user.

14. The system of claim 12, wherein ranking the set of content items comprises:
generating an embedding for each content item based at least in part on a set of features associated with each content item;
determining a proximity of each embedding to an embedding of a labeled content item related to the topic; and
determining the relevance associated with each content item based at least in part on the proximity.

15. The system of claim 12, further comprising:
determining one or more user preferences based at least in part on user signals associated with the user; and
wherein ranking the set of content items is further based at least in part on the one or more user preferences.

16. A non-transitory computer-readable storage medium including instructions that, when executed by at least one processor of a computing system, cause the computing system to perform a method comprising:
generating an embedding for a content item based at least in part on a set of features associated with the content item;
determining a topic to which the content item is related based at least in part on the embedding; and
providing the content item to a user based at least in part on the topic and a topic subscription to which the user is subscribed.

17. The non-transitory computer-readable storage medium of claim 16, further comprising:
aggregating a set of content items related to the topic; and
ranking the set of content items based at least in part on a relevance associated with each content item.

18. The non-transitory computer-readable storage medium of claim 17, further comprising:
determining a subset of content items based at least in part on whether each content item exceeds a threshold ranking; and
providing the subset of content items to the user.

19. The non-transitory computer-readable storage medium of claim 17, wherein ranking the set of content items comprises:
generating an embedding for each content item based at least in part on a set of features associated with each content item;
determining a proximity of each embedding to an embedding of a labeled content item related to the topic; and
determining the relevance associated with each content item based at least in part on the proximity.

20. The non-transitory computer-readable storage medium of claim 17, further comprising:
determining one or more user preferences based at least in part on user signals associated with the user; and
wherein ranking the set of content items is further based at least in part on the one or more user preferences.
